(19) United States
(12) Patent Application Publication
(10) Pub. No.: US 2006/0040706 A1
(43) Pub. Date: Feb. 23, 2006

(54) Hybrid space-time diversity beam forming system

(75) Inventors: Shiquan Wu, Neppen (CA); John Litva, Almonte (CA)

Correspondence Address: HOGAN & HARTSON LLP, ONE TABOR CENTER, SUITE 1500, 1200 SEVENTEENTH ST, DENVER, CO, 80202, US

(73) Assignee: shiquan WU and John litva

(21) Appl. No.: 10/535,261

(22) PCT Filed: Nov. 18, 2003
(86) PCT No.: PCT/CA03/01747

§ 371 Date: May 17, 2005

(30) Foreign Application Priority Data
Nov. 19, 2002 (US) 60427229

(51) Int. Cl. H04B 1/06; H04J 3/06; H04B 7/00; H04M 1/00

(52) U.S. Cl. 455/562.1; 455/265; 455/515; 370/350

(57) ABSTRACT

A method of beam forming is provided for an appliqué intelligent antenna system. The appliqué system uses a watchdog function to monitor broadcast channels of an existing mobile wireless base station to which it is attached. The appliqué system synchronizes itself in frequency and time to the base station. In GSM timing delays are used to prevent collision of timeslots from various mobile terminals. The appliqué system uses this time delay mechanism to compensate for its own processing delays so that its presence is transparent to the existing base station. Angle of arrival calculations are made to determining beamforming parameters. The antenna of the four element antenna system are separated by is (5^{1/2}−1)/2 times the wavelength. Angle of arrival for the strongest uplink multipath signal are used to direct the downlink beam.

### FIELD OF THE INVENTION

The present invention relates to hybrid space-time diversity beam forming, and is particularly concerned with applications to mobile wireless systems.

### BACKGROUND OF THE INVENTION

A GSM network is composed of several functional entities, whose functions and interfaces are defined. The GSM network can be divided into three broad parts. The Mobile Station is carried by the subscriber; the Base Station Subsystem controls the radio link with the Mobile Station. The Network Subsystem, the main part of which is the Mobile services Switching Center, performs the switching of calls between the mobile and other fixed or mobile network users, as well as management of mobile services, such as authentication. The Mobile Station and the Base Station Subsystem communicate across the Um interface, also known as the air interface or radio link. The Base Station Subsystem communicates with the Mobile service Switching Center across the A interface. The following table briefly describes the GSM development history

TABLE 1
GSM Development History

| | Phase 1 | Phase 2 | Phase 2+ |
|---|---|---|---|
| Specifications | 1987-1991 | 1992-1995 | 1995-1999 |
| development | | | |
| Trial period | 1992-1998 | 1998-1999 | 1998-2000 |
| Voice transmission | Full Rate | Full rate, half rate | Full rate, half rate, |
| modes | | | enhanced full rate |
| Data transmission | Full rate (9.6 kbps max) | Full rate (9.6 kbps | Full rate (11.4 kbps max), |
| | Half rate (4.8 kbps max) | max) | Half rate (4.8 kbps max), |
| | | Half rate (4.9 kbps | Packet transmission |
| | | max) | (T6.8 kbps max), |
| | | | High-speed circuit |
| | | | exchange (T8.8 kbps |
| | | | max) |
| Supplementary services | Call transfer, call | Call transfer, call | Enhanced versions of |
| | limiting | limiting, hold, caller | Phase 2 services |
| | | ID, service of | |
| | | charge, conference | |
| | | calls (6 parties max), | |
| | | etc. | |
| Short message service | Bidirectional text | Category-specific | Phase 2 capabilities |
| | transmission, cell- | text transmission | plus data packet |
| | specific announcements | (basic, voice mail | transfer and two-byte |
| | | notification | code transfer |
| Other | Global roaming 5 V BIM | Global roaming, 3- | Global and domestic |
| | card | SV SIM card, | roaming, SIM tool kit, |
| | | DCS1800 | multiband GSM, DCS |
| | | specifications | support, |
| | | | interoperability with |
| | | | DECT |

GSM Channel Structure

GSM is an FDD-TDMA system, each carrier occupies 200 kHz which is time-shared by 8 time slots or users. The structure of the most common timeslot burst is shown in FIG. 1. The structure 10 includes three tail bits 11, 58 information bits 12, 26 training bits 13, a second group of 58 information bits 14, three tail bits 15 and 8.25 guard bits 16.

A total of 156.25 bits is transmitted in 0.577 milliseconds, giving a gross bit rate of 270.833 kbps. There are three other types of burst structure for frame and carrier synchronization and frequency correction. The 26 bit training sequence 13 is used for slot timing and equalization, as described below. The 8.25 bit guard time 16 allows for some propagation time delay in the arrival of bursts.

Referring to FIG. 2, there is illustrated the GSM Frame Structure. Each group of eight time slots is called a TDMA frame 20, which is transmitted every 4.615 ms. TDMA frames are further grouped into multiframes to carry control signals to the designated slots/blocks. There are two types of multiframe 21 and 22, containing 26 or 51 TDMA frames respectively. The 26 frame multiframe contains 24 Traffic Channels (TCH) and two Slow Associated Control Channels (SACCH) that supervise each call in progress. The SACCH in frame 12 contains eight channels, one for each of the eight connections carried by the TCHs. The SACCH in frame 25 is not currently used, but will carry eight additional SACCH channels when half rate traffic is implemented. A Fast Associated Control Channel (FACCH) works by stealing slots from a traffic channel to transmit power control and handoversignalling messages. The channel stealing is done by setting one of the control bits in the time slot burst to indicate the slot carries traffic data or signaling message.

In addition to the Associated Control Channels, there are several other control channels, which except for the Standalone Dedicated Control Channel are implemented with broadcasting channel (say, in time slot 0) of specified TDMA frames in a 51 frame multiframe 22, implemented on a no hopping carrier frequency in each cell. The control channels include:
Broadcast Control Channel (BCCH): Continually broadcasts, on the downlink, information including base station identity, frequency allocations, and frequency hopping sequences etc.
Standalone Dedicated Control Channel (SDCCH): Used for registration, authentication, call setup, and location updating. Implemented on a time slot, together with its SACCH, selected by the system operator.
Common Control Channel (CCCH): Comprised of three control channels used during call origination and call paging.
   Random Access Channel (RACH): A slotted Aloha channel to request access to the network
   Paging Channel (PCH): Used to alert the mobile station of incoming call.
   Access Grant Channel (AGCH): Used to allocate an SDCCH to a mobile for signaling, following a request on the RACH.
      GSM Frame Structure and Numbering

The TDMA technique means that the data are multiplexed in time blocks, in GSM one uses slots or frames. The frames are then grouped into multi-traffic frames (26 normal frames) or multi-control frames (51 normal frames). These two types of multi-frames are grouped again into super-frames 23 and 24 with 26×51 normal frames. So the numbering of each frame is start from 0 to 2048×26×51−1=2,715,647. The hyperframe 25 is the largest cycle and is repeated in the network.

Mobile needs to inform the network the signal strength information from surrounding cells by signaling channels such as Associated Control Channel.
Bandwidth required to send the measurement information is 1/24 of that required for voice.

The following table summarizes the structure and numbering.

| | Traffic Channel | | Control | |
|---|---|---|---|---|
| | (TCH) | Consists of: | Channel (CCH) | Consists of: |
| TDMA | 4.6 ms | 8 Timeslots | 4.6 ms | 8 Timeslots |
| frame | | | | |
| Multiframe | 120 ms | 26 TDMA | 234 ms | 51 TDMA |
| | | frames | | frames |
| Superframe | 6 s 120 ms | 51 Multiframes | 6 s 120 ms | 26 Multiframes |
| Hyperframe | 3 h 28 m 53 s 760 ms | 2048 | 3 h 28 m 53 s | 2048 |
| | | Superframes | 760 ms | Superframes |

Frame Synchronized Transmission

For each carrier with 200 kHz spectrum, a maximum of 8 users may share this spectrum in time domain. The biggest issue in uplink is to guarantee that those signals from randomly appearing users do not overlap each other in time slots while keeping the overhead small. GSM has designed a so called ‘Timing Advance’ to resolve this issue. Referring to FIG. 3 there is graphically illustrated the timing advance zones of GSM.

In GSM, the targeting range is up to 35 km radius 26 of the Base Station (BS). A round trip delay for the far most point is 233.3 μs. In order to guarantee uplink signals of the same carrier will not overlap each other, a guard time is necessary for each mobile. To handle 233.3 μs round trip delay, we need 252 μs (or 68.25 bits) which is bad in terms of the spectrum efficiency. So only the RACH has this luxury. The traffic channels cannot waste that much bandwidth. The ‘timing advance’ used in GSM causes a mobile to transmit earlier than just 3 slot delay relative to downlink timing.

Referring to FIG. 4, there is graphically illustrated the GSM timing advance processing. The BS transmits a burst 30. The MS receives it 32 T(1) later. The MS transmits a burst 34, 3 slots later. The BS receive it 36 T(2) later. When a base station detects a RACH, it meanwhile measures the round trip delay T(1)+T(2) and derives the delay from mobile to BS. This delay is called timing advance and is signaled to mobile to adjust its transmitting time 38 to 3 slot minus that timing advance. In summary, the maximum round trip delay 233.3 μs is quantized to a 6 bit number, so 64 steps (0-63) possible timing advance. Each step advances the Timing by one bit duration 48/13 (233.3/63) μs which is about 70/64=1,0938 km. This timing advance process can reduce the guard time to be 8.25×3.7=30.525 μs rather than 252 μs required for the maximum round trip.

64 steps allows for compensation over a maximum one way propagation time of 31.5 bit periods i.e. 116.3 μs (i.e. a maximum distance of ˜35 km)

Initial Timing advance: BS instructs the MS who advances its burst transmission by a time corresponding to round trip delay. The maximum timing advance value is 63. (GSM 03.30 defines how PLMN deals with MS when the timing advance value is greater then 63).

Tracking Mode Timing Advance: The BS continuously monitors the delay of the normal bursts sent by MS. If the delay changes by more than 1 bit period, the timing advance shall be advanced or retarded only 1 bit and the new value signaled to MS. The purpose of restricting the timing advance to 1-bit period each time is to simplify the implementation in BS. However, BS may use “large” stepsize (ref GSM 05.10)

The Timing Advance is used to compensate for the time it takes a RF signal to go at the speed of light between the BTS and MS. The maximum BTS radius of 35 km is divided into 64 TA steps (This means 547 meters/TA step—As a simplification 550 meters is used). The TA multiplied with 550 meters gives the minimum distance to the BTS. The maximum distance is 550 mx (TA+1). A TA value places a BTS in a circular band 550 meters wide, with an inner radius of (TA×550) meters.

| | Timing Advance | | | | | | | |
|---|---|---|---|---|---|---|---|---|
| | 0 | 1 | 2 | 3 | 4 | 5 | . . . | 63 |
| Distance to | <550 m | 550 m-1100 m | 1100 m-1650 m | 1650 m-2200 m | 2200 m-2750 m | 2750 m-3300 m | . . . | 35 Km |
| BTS | | | | | | | | |

Speech Coding and Channel Coding

Referring to FIG. 5, there is illustrated the speech coding and channel coding for GSM. GSM is a digital system, so speech signals, which are inherently analog, have to be digitized. The method employed by ISDN, and by current telephone systems for multiplexing voice lines over high-speed trunks and optical fiber lines, is Pulse Coded Modulation (PCM). The output stream from PCM is 64 kbps, too high a rate to be feasible over a radio link. The 64 kbps signal contains much redundancy, although it is simple to implement. The GSM group studied several voice coding algorithms on the basis of subjective speech quality and complexity (which is related to cost, processing delay, and power consumption once implemented) before arriving at the choice of a Regular Pulse Excited—Linear Predictive Coder (RPELPC) with a Long Term Predictor loop. Basically, information from previous samples, which does not change very quickly, is used to predict the current sample. The coefficients of the linear combination of the previous samples, plus an encoded form of the residual, the difference between the predicted and actual sample, represent the signal. Speech is divided into 20 millisecond samples, each of which is encoded as 260 bits 40, giving a total bit rate of 13 kbps.

Due to natural or manmade electromagnetic interference, the encoded speech or data transmitted over the radio interface must be protected as much as is practical. The GSM system uses convolutional encoding and block interleaving to achieve this protection. The exact algorithms used differ for speech and for different data rates. The method used for speech blocks is described below.

Recall that the speech codec produces a 260-bit block for every 20 ms speech sample. From subjective testing, it was found that some bits of this block were more important for perceived speech quality than others. The bits are thus divided into three classes:

Class Ia 50 bits - most sensitive to bit errors
Class Ib 132 bits - moderately sensitive to bit errors
Class II 78 bits - least sensitive to bit errors

Class Ia bits have a 3 bit Cyclic Redundancy Code added for error detection. If an error is detected, the frame is judged too damaged to be comprehensible and it is discarded. It is replaced by a slightly attenuated version of the previous correctly received frame. These 53 bits, together with the 132 Class Ib bits and a 4-bit tail sequence (a total of 189 bits), are input into a ½ rate convolutional encoder of constraint length 4. Each input bit is encoded as two output bits, based on a combination of the previous 4 input bits. The convolutional encoder thus outputs 378 bits, to which are added the 78 remaining Class II bits, which are unprotected. Thus every 20 ms speech sample is encoded as 456 bits 42, giving a bit rate of 22.8 kbps. To further protect against the burst errors common to the radio interface, each sample is diagonally interleaved. The 456 bits output by the convolutional encoder are divided into 8 blocks of 57 bits 44, and these blocks are transmitted in eight consecutive timeslot bursts 46. Since each timeslot burst can carry two 57-bit blocks, each burst carries traffic from two different speech samples.

Recall that each timeslot burst is transmitted at a gross bit rate of 270.833 kbps. This digital signal is modulated onto the analog carrier frequency, which has a bandwidth of 200 kHz, using Gaussian filtered Minimum Shift Keying (GMSK). GMSK was selected over other modulation schemes as a compromise between spectral efficiency, complexity of the transmitter, and limited spurious emissions. The complexity of the transmitter is related to power consumption, which should be minimized for the mobile station. The spurious radio emissions, outside of the allotted bandwidth, must be strictly controlled so as to limit adjacent channel interference, and allow for the coexistence of GSM and the older analog systems (at least for the time being).

Referring to FIG. 6, there is illustrated in a block diagram a GSM transmitter. The GSM transmitter main 50 includes a voice Codec 52 coupled to a voice digityzer 54, and outputting to a channel encoder and interleaver 56. The output of which is input to MUX 58 then GMSK modulator 60 and channelizer 62 for transmission.

Modulating Symbol Rate

The modulating symbol rate is 1/T=1 625/6 ksymb/s (i.e. approximately 270.833 ksymb/s), which corresponds to 1 625/6 kbit/s (i.e. 270.833 kbit/s),

Start and Stop of the Burst

Before the first bit of the bursts as defined in GSM 05.02 [3] enters the modulator, the modulator has an internal state as if a modulating bit stream consisting of consecutive ones (dᵢ=1) had entered the differential encoder. Also after the last bit of the time slot, the modulator has an internal state as if a modulating bit stream consisting of consecutive ones (dᵢ=1) had continued to enter the differential encoder. These bits are called dummy bits and define the start and the stop of the active and the useful part of the burst as illustrated in FIG. 1. Nothing is specified about the actual phase of the modulator output signal outside the useful part of the burst.

Differential Encoding

Each data value dᵢ=[0,1] is differentially encoded. The output of the differential encoder is:
\hat{d}ᵢ=dᵢ⊕dᵢ₋₁(dᵢε{0,1})
where ⊕ denotes modulo 2 addition.
The modulating data value bᵢ input to the modulator is:
bᵢ=1−2\hat{d}ᵢ(bᵢε{−1,+1})
Training Sequence

There are eight training sequences are designed in GSM system. Each slot/user has a unique training sequence as a midamble. Each training sequence has 26 bits and the sequences were designed to have a good cross correlationship.
Slot-1 Training=[0,0,1,0,0,1,0,1,1,1,0,0,0,0,1,0,0,0,1,0,0,1,0,1,1,1];
Slot-2 Training=[0,0,1,0,1,1,0,1,1,1,0,1,1,1,1,0,0,0,1,0,1,1,0,1,1,1];
Slot-3 Training=[0,1,0,0,0,0,1,1,1,0,1,1,1,0,1,0,0,1,0,0,0,0,1,1,1,0];
Slot-4 Training=[0,1,0,0,0,1,1,1,1,0,1,1,0,1,0,0,0,1,0,0,0,1,1,1,1,0];
Slot-5 Training=[0,0,0,1,1,0,1,0,1,1,1,0,0,1,0,0,0,0,0,1,1,0,1,0,1,1];
Slot-6 Training=[0,1,0,0,1,1,1,0,1,0,1,1,0,0,0,0,0,1,0,0,1,1,1,0,1,0];
Slot-7 Training=[1,0,1,0,0,1,1,1,1,1,0,1,1,0,0,0,1,0,1,0,0,1,1,1,1,1];
Slot-8 Training=[1,1,1,0,1,1,1,1,0,0,0,1,0,0,1,0,1,1,1,0,1,1,1,1,0,0];
   Filtering

The modulating data values αᵢ as represented by Dirac pulses that excite a linear filter with impulse response defined by:

$$g ( t ) = {h ( t )}^{*} rect ( \frac{t}{T} )$$

where the function rect(x) is defined by:

$$\begin{matrix}rect ( \frac{t}{T} ) = \frac{1}{T} & for \vert t \vert < \frac{T}{2} \\ rect ( \frac{t}{T} ) = 0 & otherwise\end{matrix}$$

and * means convolution. h(t) is defined by:

$$h ( t ) = \frac{exp ( \frac{- {t}^{2}}{2 {δ}^{2} {T}^{2}} )}{\sqrt{( 2 π )} \cdot δ T} where$$

$$δ = \frac{\sqrt{ln ( 2 )}}{2 π BT} and BT = 0.3$$

where B is the 3 dB bandwidth of the filter with impulse response h(t), and T is the duration of one input data bit. This theoretical filter is associated with tolerances defined in GSM 05.05 [4].
Output Phase

The phase of the modulated signal is:

$$φ ( {t}^{′} ) = {\sum }_{i}^{} {α}_{i} π h {\int }_{- ∞}^{{t}^{′} - iT} g ( u ) ⅆ u$$

where the modulating index h is ½ (maximum phase change in radians is π/2 per data interval).

The time reference t′=0 is the start of the active part of the burst as shown in FIG. 1. This is also the start of the bit period of bit number 0 (the first tail bit) as defined in GSM 05.02 [2];

Modulation

The modulated RF carrier, except for start and stop of the TDMA burst may therefore be expressed as:

$$x ( {t}^{′} ) = \sqrt{\frac{2 {E}_{c}}{T}} \cdot cos ( 2 π {f}_{0} {t}^{′} + φ ( {t}^{′} ) + {φ}_{0} )$$

where E_{c} is the energy per modulating bit, f₀ is the center frequency and φ₀ is a random phase and is constant during one burst.
GSM Receiver Chain

Referring to FIG. 8, there is illustrated in a block diagram a GSM receiver. The GSM receiver 70 includes a splitter 72, a demodulation 74, a DEMUX 76 a channel decoder and deinterleaver 78 the output of which is coupled to a speech decoder and digital to analogue converter (DAC) 80. At the 900 MHz range, radio waves bounce off everything—buildings, hills, cars, airplanes, etc. Thus many reflected signals, each with a different phase, could reach an antenna. Equalization is used to extract the desired signal from the unwanted reflections. Equalization works by finding out how a known transmitted signal is modified by multipath fading, and constructing an inverse filter to extract the rest of the desired signal. This known signal is the 26 bit training sequence transmitted in the middle of every time slot burst. The actual implementation of the equalizer is not specified in the GSM specifications.

Matching Filter

After down converter and ADC, the received sampled data is usually flittered by an anti-alising filter, which will decide the sample phase so that to decimate to symbol rate data.

Time Synchronization

The 26 known bits are used to do a correlation base search and to find the slot boundary

Channel Estimation

Again, using the known 26 bits to do the channel estimation. A) Correlation based. B) Least mean square error solution.

Viterbi Equalization

With the estimated channel (usually 5 0r 7 taps), enumeration search on the possibility set is pursued to find the possible bit sequence, which will be the input for channel decoder.

GSM has become a very successful wireless scheme with repaid subscriber growth in its areas of deployment. In fact growth has been in such a rapid rate that the capital costs of installed infrastructure has not had enough time to pay for itself before further equipment deployment must be made in order to service now subscribers. This growth related problem has been most acutely felt in urban areas. Consequently, wireless service providers need to find a way to provide services to a growing customer base without growing the infrastructure at the same rate.

### SUMMARY OF THE INVENTION

An object of the present invention is to provide a hybrid space-time diversity beam forming system.

In accordance with an aspect of the present invention there is provided a method of beam forming comprising the steps of: in an appliqué intelligent antenna system, monitoring broadcast channels of a mobile wireless base station; monitoring a frequency burst broadcast by the base station and synchronizing the appliqué system in frequency; monitoring a synchronization burst in the broadcasting channel and synchronizing the appliqué system with the mobile wireless base station in time.

Conveniently, a step of determining an angle of arrival includes the step of determining a covariance matrix XX, where X is given by:

$$[ \begin{matrix}R1 ( 62 ) R2 ( 62 ) R3 ( 62 ) R4 ( 62 ) \\ R1 ( 63 ) R2 ( 63 ) R3 ( 63 ) R4 ( 63 ) \\ R1 ( 64 ) R2 ( 64 ) R3 ( 64 ) R4 ( 64 ) \\ ⋮ \\ R1 ( 87 ) R2 ( 87 ) R3 ( 87 ) R4 ( 87 )\end{matrix} ]$$

$$And XX = {X}^{*} \cdot X$$

Conveniently, the step of determining the angle of arrival includes the step of forming a Hermitian Toeplitz matrix by using XX with the following procedures
Z₀[XX(1,1)+XX(2,2)+XX(3,3)+XX(4,4)]/4;
Z₁=[XX(1,2)+XX(2,3)+XX(3,4)]/3;
Z₂=[XX(1,3)+XX(2,4)]/2;
Z₃=XX(1,4)

An advantage of the present invention is increasing the subscriber capacity of an existing base station.

### BRIEF DESCRIPTION OF THE DRAWINGS

The present invention will be further understood from the following detailed description with reference to the drawings in which:

FIG. 1 illustrates a known CSM common burst slot structure;

FIG. 2 illustrates a known GSM frame structure;

FIG. 3 graphically illustrates known timing advance zones for GSM;

FIG. 4 graphically illustrates known timing advance processing for GSM;

FIG. 5 illustrates known speech coding and channel coding for GSM;

FIG. 6 illustrates in a block diagram a known GSM transmitter chain;

FIG. 7 graphically illustrates a known relationship between active part of burst, tail bits and dummy bits;

FIG. 8 illustrates in a block diagram a known GSM receiver chain;

FIG. 9 illustrates a four-element linear antenna array system in accordance with an embodiment of the present invention;

FIGS. 10 and 11 illustrate a simplified receiver portion and transmitter portion, respectively of an appliqué intelligent antenna system for use with the antenna array system of FIG. 9 in accordance with an embodiment of the present invention;

FIG. 12 illustrates a receiver for the antenna array system of FIG. 9 in accordance with an embodiment of the present invention;

FIG. 13 illustrates in a block diagram a transmitter for the intelligent antenna system in accordance with an embodiment of the present invention;

FIGS. 14 and 15 illustrate the detailed arrangement of information in the SCH message; and

FIG. 16 graphically illustrates downlink beam patterns.

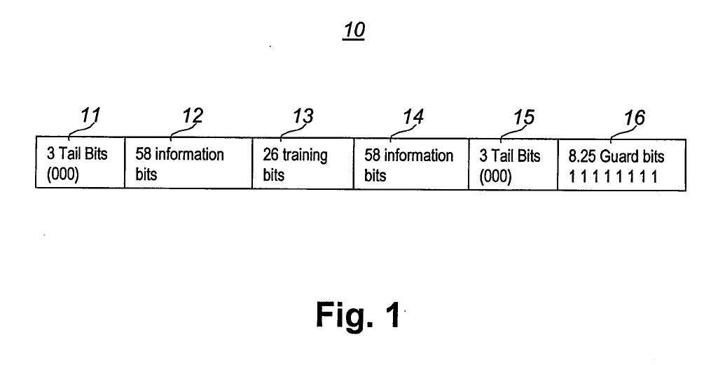

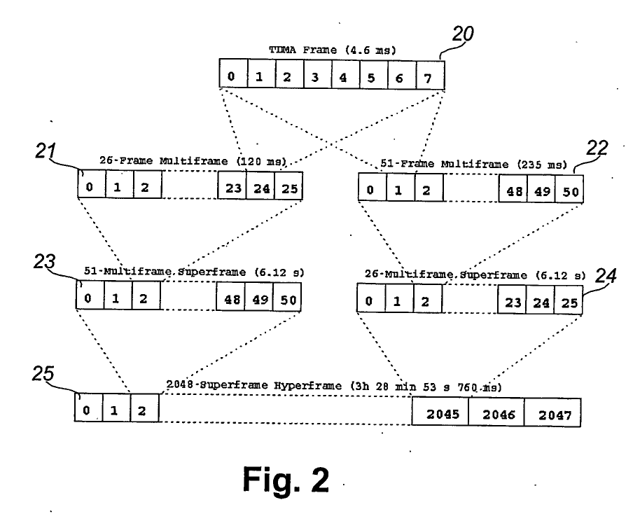

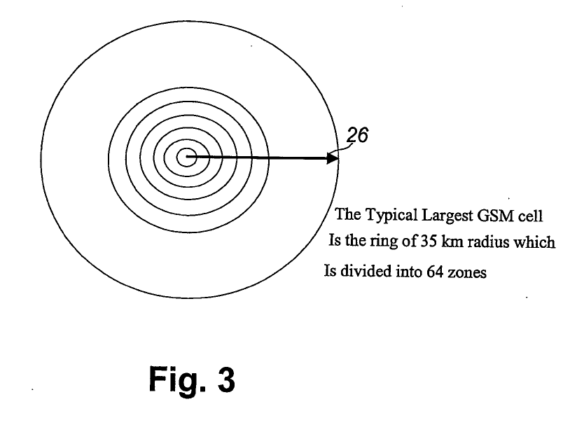

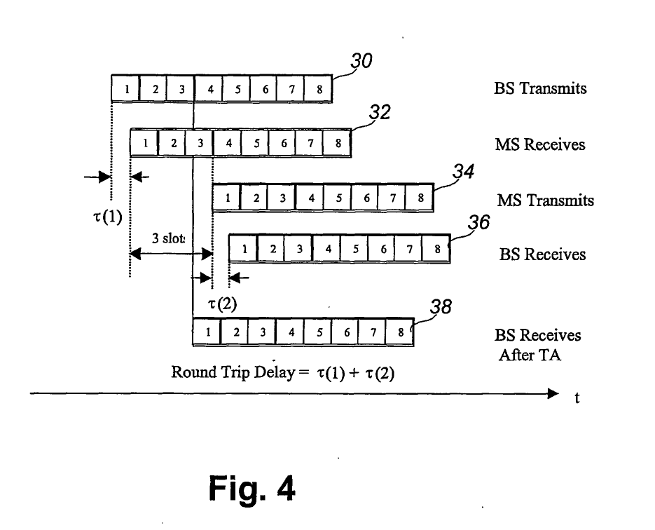

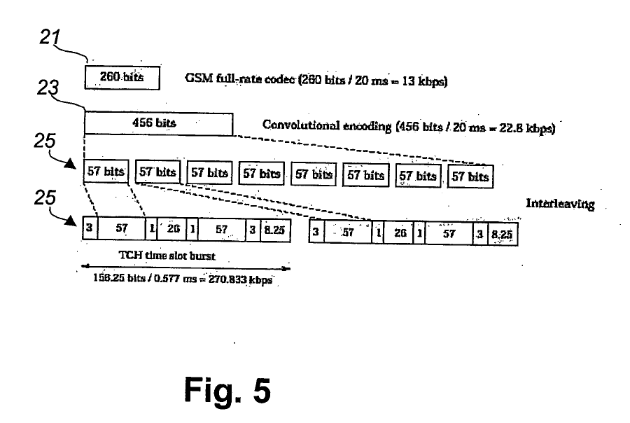

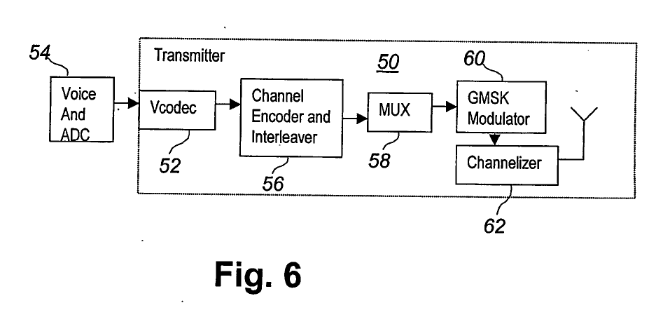

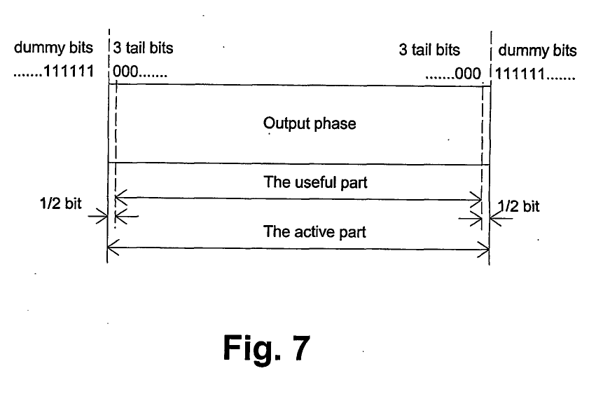

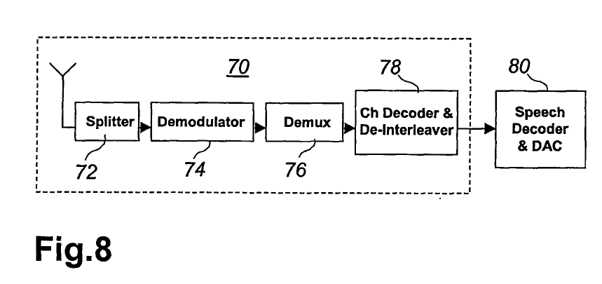

### DETAILED DESCRIPTION OF THE PREFERRED EMBODIMENT

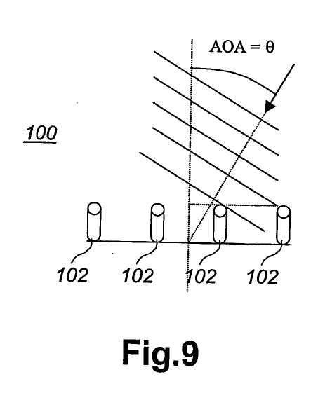

Referring to FIG. 9, there is illustrated a four-element linear antenna array system in accordance with an embodiment of the present invention. The four element linear antenna array system 100 includes antennas 102 spaced a distance d=0.618 wavelength apart. This is actually the golden number, which we found to be the best compromise between traditional linear array antennas and diversity antennas. With this golden separation, we can collect antennae diversity while keeping the merits of the linear array processing gains. In an embodiment of the present invention the antenna element spacing is (5^{1/2}−1)/2 times the wavelength.

The four-element linear array system of FIG. 9 is designed to improve the link quality of both uplink and down link. The four-element linear array system including beam-forming technology is implemented for both uplink and downlink, which can be integrated into the customer's base station TRU. The principle of a linear array can be illustrated in the following array model. Suppose a signal, s(t)=B(t)exp(j2πft) with a base band signal B(t), being transmitted from a mobile phone, is impinging the linear array. Regarding to the physical array, the signal wave can be regarded as a plane wave.

Suppose the distance between the two adjacent elements is d meters, as the signal propagate with light speed c, so the signal arrives the 2^{nd} element will be delayed by d×sin(θ)/c seconds. Similarly, the signal arrives at 3^{rd} array element will be delayed by 2×d×sin(θ)/c and arrives at 4^{th} element will be delayed by 3×d×sin(θ)/c. As the symbol duration (48/13 micro seconds) is much larger then the duration of the signal sweeps of the array, the narrow band signal received by each element can be regarded as unchanged except its phase. Then we may model the array output is

$$[ \begin{matrix}{x}_{1} ( t ) \\ {x}_{2} ( t ) \\ {x}_{3} ( t ) \\ {x}_{4} ( t )\end{matrix} ] = s ( t ) [ \begin{matrix}1 \\ exp ( j2π f \times d \times sin ( θ ) / c ) \\ exp ( j2π f \times 2 \times d \times sin ( θ ) / c ) \\ exp ( j2π f \times 3 \times d \times sin ( θ ) / c )\end{matrix} ] = s ( t ) [ \begin{matrix}1 \\ exp ( j2π f \times d \times sin ( θ ) / λ ) \\ exp ( j2π f \times 2 \times d \times sin ( θ ) / λ ) \\ exp ( j2π f \times 3 \times d \times sin ( θ ) / λ )\end{matrix} ] \qquad ( 1 )$$

where λ=c/f is the wavelength. A particular design is to make the distance between every two adjacent elements equals to half wavelength, and then the above equation can be simplified as:

$$[ \begin{matrix}{x}_{1} ( t ) \\ {x}_{2} ( t ) \\ {x}_{3} ( t ) \\ {x}_{4} ( t )\end{matrix} ] = s ( t ) [ \begin{matrix}1 \\ exp ( jπ sin ( θ ) ) \\ exp ( jπ \times 2 \times sin ( θ ) ) \\ exp ( jπ \times 3 \times sin ( θ ) )\end{matrix} ] \qquad ( 2 )$$

Note that we have assumed the signal received by the 1^{st} array element has no propagation delay. This is only true after the received signal has been synchronized with transmission timing. Also we did not count any imperfections such as multipath, interference and noise and so on. More generically, we can assume many signals along with their multipath copies are simultaneously impinging the array.

For GSM, as it is FDD-TDMA system, only one desired signal and its multipath need to be extracted, other impinging signals are interference or noise that need to be suppressed as much as possible. We now suppose the desired signal is propagated via L paths. After demodulation, the received baseband array output can be modeled as

$$\begin{matrix}[ \begin{matrix}{y}_{1} ( t ) \\ {y}_{2} ( t ) \\ {y}_{3} ( t ) \\ {y}_{4} ( t )\end{matrix} ] = {\sum }_{l = 1}^{L} α ( l ) B ( t - τ ( l ) ) [ \begin{matrix}1 \\ exp ( j2π \times d \times sin ( θ ( l ) ) / λ ) \\ exp ( j2π \times 2 d \times sin ( θ ( l ) ) / λ ) \\ exp ( j2π \times 3 d \times sin ( θ ( l ) ) / λ )\end{matrix} ] + I ( t ) \\ = [ \begin{matrix}\{ b ( i ) \} ⊗ {ch}_{1} ( t ) \\ \{ b ( i ) \} ⊗ {ch}_{2} ( t ) \\ \{ b ( i ) \} ⊗ {ch}_{3} ( t ) \\ \{ b ( i ) \} ⊗ {ch}_{4} ( t )\end{matrix} ] + I ( t )\end{matrix} \qquad ( 3 )$$

where {b (i)} is the transmitted symbol sequence, I(t) is the overall noise and interference effect, chₖ(t) is the multipath channel modulated by the array steering vectors. More precisely,

$$\begin{matrix}\begin{matrix}\begin{matrix}{ch}_{1} ( t ) = {\sum }_{l = 1}^{L} α ( l ) h ( t - τ ( l ) ) \\ {ch}_{2} ( t ) = {\sum }_{l = 1}^{L} α ( l ) exp ( j 2 π \times d \times sin ( θ ( l ) ) / λ ) h ( t - τ ( l ) )\end{matrix} \\ {ch}_{3} ( t ) = {\sum }_{l = 1}^{L} α ( l ) exp ( j 2 π \times 2 d \times sin ( θ ( l ) ) / λ ) h ( t - τ ( l ) )\end{matrix} \\ {ch}_{4} ( t ) = {\sum }_{l = 1}^{L} α ( l ) exp ( j 2 π \times 3 d \times sin ( θ ( l ) ) / λ ) h ( t - τ ( l ) )\end{matrix} \qquad ( 4 )$$

where h(t) is the overall channel impulse response.

The four-element linear array system fully utilizes the known sequence to estimate all the parameters such as slot boundary, angle of arrival (AOA) and time of arrival (TOA) of the strongest path, channel impulse response which is used for both uplink decoding and downlink transmission.

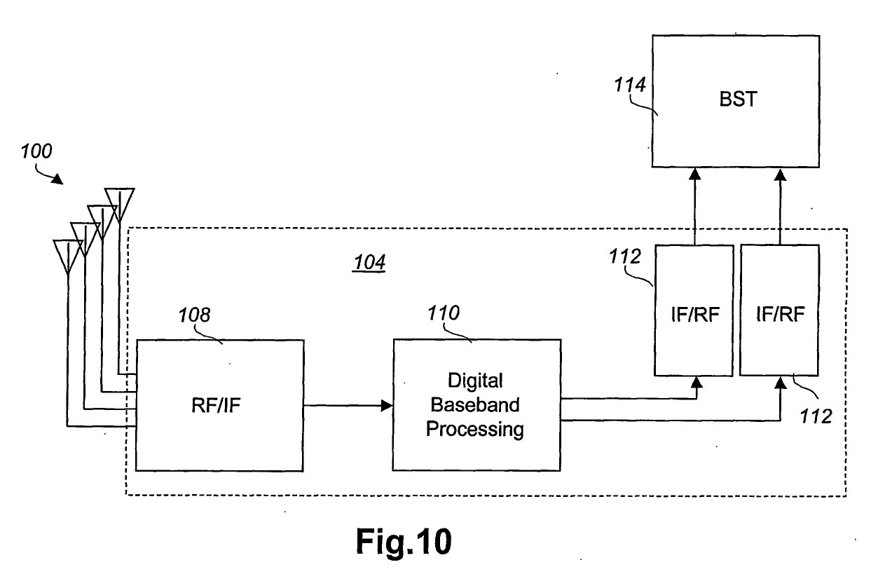

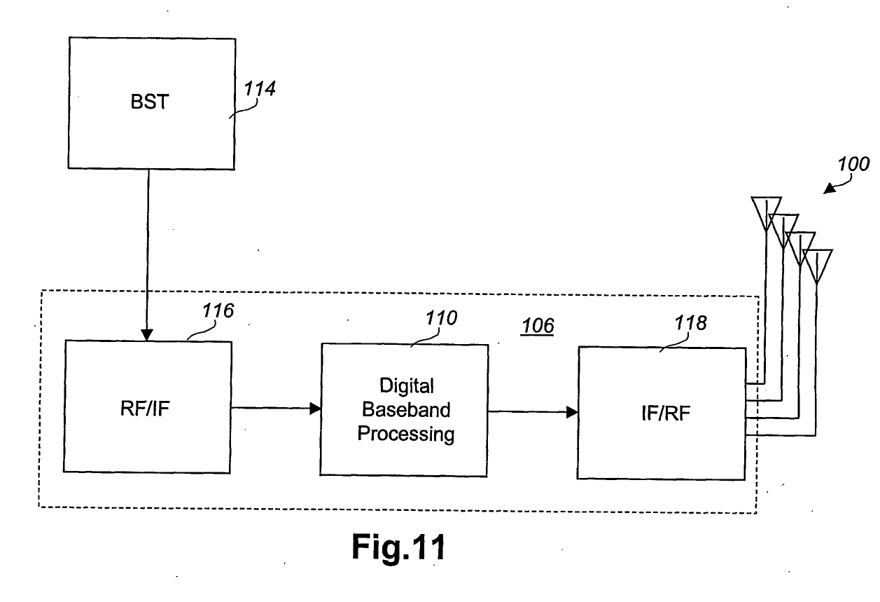

Referring to FIGS. 10 and 11, there are illustrated a simplified receiver portion 104 and transmitter portion 106, respectively of an appliqué intelligent antenna system for use with the antenna array system of FIG. 9 in accordance with an embodiment of the present invention. On the receive portion 104, the antenna array system 100 is coupled to an RF/IF down-converter 108 that provides input to a digital base-band processing block 110 whose output is applied to an IF/RF up-converter 112. The output of the IF/RF up-converter 112 is applied to an existing base station 114. On the transmit portion 106, the existing base station 114 is coupled to an RF/IF down-converter 116 that provides input to the digital base-band processing block 110 whose output is applied to an IF/RF up-converter 118. The output of the IF/RF up-converter 118 is applied to an antenna array system 100. Consequently, both receive and transmit portions of the appliqué intelligent antenna system are transparent to the existing base station.

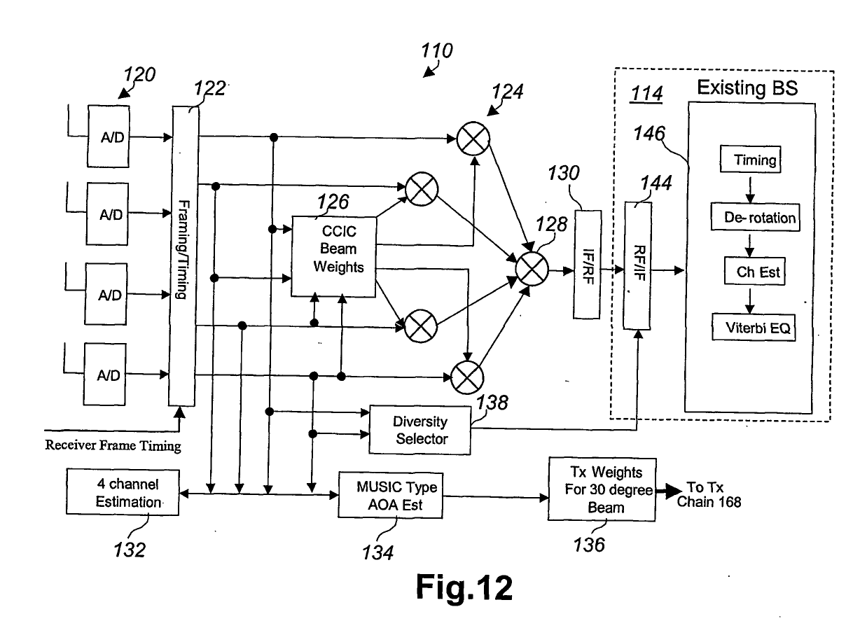

Referring to FIG. 12, there is illustrated the receive portion of FIG. 10 in further detail. The receive portion 104 includes four analog-to-digital converters (A/D) 120 each coupled to a respective antenna 102 with outputs coupled to a slot framing and timing block 122. The outputs of the slot framing and timing block 122 are each applied to a respective mixer 124 and separately applied to a beam weight block 126. The outputs of the beam weight block 126 are applied to the mixer 124 whose outputs are applied to an adder 128, whose output is applied as input to an IF/RF up-converter 130. The outputs of framing/timing block 122 are also applied to a four-channel estimation block 132 and an angle of arrival (AOA) estimation block 134. The AOA estimation block 134 is output to a transmit weight block 136 whose output is coupled to a transmitter chain (not shown in FIG. 12). The outputs of the framing and timing block 122 corresponding to the outer antennas of the array are coupled to a diversity selector 138. In operation, the slot framing/timing block is similar to a GSM timing block, i.e. it uses the known 26 bits to do correlation with the received samples and to find out the accurate slot boundary. One difference from typical GSM is here we have four data flow inputs instead of one, hence the framing/timing here pursues a common timing for all four data flows.

Note that, in this stage, we have made the assumption that the four-element antenna array system has acquired the BS timing from the synchronization burst (see the Watchdog description herein below for details).

The output of this block will be a slot wise data vector with symbol rate or over sampling rate. The sampling rate M is specified to be 1, 2 and 4 samples per symbol. The complexity for this block is summarized in the following table.

TABLE 1
Complexity of Slot Framing

| Searching Window | Pseudo MPX | M = 2 | M = 4 |
|---|---|---|---|
| 7 symbols | 4 × 7 × M × 26 = | 1456 | 2912 |

Pseudo multiplication means the implementation can be done as an ‘adder’ since the known sequence is a sort of +1, −1, +j, −j.

The CCIC Beamformer Weights Block 126 is responsible for calculating the beamformer weights which are used to combine the four data flows to form the input for the known base station receiver 142.
Space-Time Diversity Beamforming (STDB) Algorithm

Suppose the framed symbol rate slot data is

$${y}_{1} = R1 ( 1 ) , R1 ( 2 ) , R1 ( 3 ) , R1 ( 4 ) , … , R1 ( 61 ) , R1 ( 62 ) , … , R1 ( 87 ) , R1 ( 88 ) , … , R1 ( 145 ) , R1 ( 146 ) , R1 ( 147 ) , R1 ( 148 ) , R1 ( 149 ) , … , R1 ( 156 )$$

$${y}_{2} = R2 ( 1 ) , R2 ( 2 ) , R2 ( 3 ) , R2 ( 4 ) , … , R2 ( 61 ) , R2 ( 62 ) , … , R2 ( 87 ) , R2 ( 88 ) , … , R2 ( 145 ) , R2 ( 146 ) , R2 ( 147 ) , R2 ( 148 ) , R2 ( 149 ) , … , R2 ( 156 )$$

$${y}_{3} = R3 ( 1 ) , R3 ( 2 ) , R3 ( 3 ) , R3 ( 4 ) , … , R3 ( 61 ) , R3 ( 62 ) , … , R3 ( 87 ) , R3 ( 88 ) , … , R3 ( 145 ) , R3 ( 146 ) , R3 ( 147 ) , R3 ( 148 ) , R3 ( 149 ) , … , R3 ( 156 )$$

$${y}_{4} = R4 ( 1 ) , R4 ( 2 ) , R4 ( 3 ) , R4 ( 4 ) , … , R4 ( 61 ) , R4 ( 62 ) , … , R4 ( 87 ) , R4 ( 88 ) , … , R4 ( 145 ) , R4 ( 146 ) , R4 ( 147 ) , R4 ( 148 ) , R4 ( 149 ) … R4 ( 156 )$$

Refer to equation (3); the array output at time k can be expressed as

$$[ \begin{matrix}{y}_{1} ( k ) \\ {y}_{2} ( k ) \\ {y}_{3} ( k ) \\ {y}_{4} ( k )\end{matrix} ] = ( \begin{matrix}{ch}_{1} ( 0 ) & {ch}_{1} ( 1 ) & … & {ch}_{1} ( 6 ) \\ {ch}_{2} ( 0 ) & {ch}_{2} ( 1 ) & … & {ch}_{2} ( 6 ) \\ {ch}_{3} ( 0 ) & {ch}_{3} ( 1 ) & … & {ch}_{3} ( 6 ) \\ {ch}_{4} ( 0 ) & {ch}_{4} ( 1 ) & … & {ch}_{4} ( 6 )\end{matrix} ) ( \begin{matrix}s ( k ) \\ s ( k - 1 ) \\ ⋮ \\ s ( k - 6 )\end{matrix} )$$

where ch1, ch2, ch3 and ch4 are the estimated channel impulse response, s(k)'s are the transmitted MSK symbols. Especially when we choose those s(k)'s to be the 26 known training sequence and arrange the array output into a space-time data array as

$$[ \begin{matrix}{y}_{1} ( k ) & {y}_{1} ( k + 1 ) & … & {y}_{1} ( k + 25 ) \\ {y}_{2} ( k ) & {y}_{2} ( k + 1 ) & … & {y}_{2} ( k + 25 ) \\ {y}_{3} ( k ) & {y}_{3} ( k + 1 ) & … & {y}_{3} ( k + 25 ) \\ {y}_{4} ( k ) & {y}_{4} ( k + 1 ) & … & {y}_{4} ( k + 25 )\end{matrix} ] = ( \begin{matrix}{ch}_{1} ( 0 ) & {ch}_{1} ( 1 ) & … & {ch}_{1} ( 6 ) \\ {ch}_{2} ( 0 ) & {ch}_{2} ( 1 ) & … & {ch}_{2} ( 6 ) \\ {ch}_{3} ( 0 ) & {ch}_{3} ( 1 ) & … & {ch}_{3} ( 6 ) \\ {ch}_{4} ( 0 ) & {ch}_{4} ( 1 ) & … & {ch}_{4} ( 6 )\end{matrix} ) ( \begin{matrix}s ( k ) & s ( k + 1 ) & … & s ( k + 25 ) \\ s ( k - 1 ) & s ( k ) & … & s ( k + 24 ) \\ … & … & … & … \\ s ( k - 6 ) & s ( k - 5 ) & … & s ( k + 19 )\end{matrix} ) + IN$$

Note that in this equation, only IN, the interference plus noise seems unknown and we should mininmize its affect. So our optimal beamformer will be chosen such that
min{w^{T}ININ^{T}W=w^{T}(Y−ChS)(Y−ChS)^{T}w,s.t.∥w∥²=1}.

The solution for this minimization problem is again an eigenvalue problem of a 4×4 semi-definite positive Hermitian matrix, that has an explicit solution. One way to solve this optimization problem is to do an eigen value decomposition for the 4×4 Hermitian matrix (Y−ChS)(Y−ChS)^{T}.

The Complexity of this block is summarized in the following table.

TABLE 2
Complexity of Algorithm I

| | | | | Total |
|---|---|---|---|---|
| | Complex MPY | Real MPY | Real Addition | Instructions |
| Conj(X)^{T} X | 4 * 26 = 104 | 416 | 240 | |
| Inv (XX) | 64 | 256 | 16 | |
| y | 4 * 26 = 104 | 416 | 240 | |
| W | 16 | 64 | 24 | 1672 |

Remark: The big difference between the present implementation and others is the treatment for the correlation matrix XX when it is invertible.

Beamforming Block

Combine the four data vectors by using formula Db(k)=conj(w(1))R1(k)+conj(w(2))R2(k)+conj(w(3))R3(k)+conj(w(4))R4(k), for k=1, 2, . . . , 156.

Up convert to RF at block 140 and then feed into receiver 142 having down connector 144 and receiver block 146.

The complexity of this block is summarized in the following table.

TABLE 3
Complexity of Beamforming Block

| | Complex | | | Total |
|---|---|---|---|---|
| | MPY | Real MPY | Real Addition | Instruction |
| Slot Combine | 624 | 2496 | 936 | 3432 |

Diversity Selection Block

The diversity selection block 138 selects one of the outputs of Antenna A and Antenna D (the two antennae locate at the edges) as one of the two inputs into the existing TRX.

AOA Estimation Block

This block estimates the angle of arrival (AOA) of the strongest path that is used for the downlink beamforming. The covariance matrix XX calculated in the beam former block is re-used in this block (this connection not shown in FIG. 10). But as there is only a 26 known bits sequence, preferably 4 samples per symbol data is used for this block. Where X is given by:

$$[ \begin{matrix}R1 ( 62 ) R2 ( 62 ) R3 ( 62 ) R4 ( 62 ) \\ R1 ( 63 ) R2 ( 63 ) R3 ( 63 ) R4 ( 63 ) \\ R1 ( 64 ) R2 ( 64 ) R3 ( 64 ) R4 ( 64 ) \\ ⋮ \\ R1 ( 87 ) R2 ( 87 ) R3 ( 87 ) R4 ( 87 )\end{matrix} ]$$

$$And XX = {X}^{*} \cdot X$$

Form a Hermitian Toeplitz matrix by using XX with the following procedures

$$\begin{matrix}\begin{matrix}\begin{matrix}\begin{matrix} {Z}_{0} = [ XX ( 1 , 1 ) + XX ( 2 , 2 ) + XX ( 3 , 3 ) + XX ( 4 , 4 ) ] / 4 ; \\ {Z}_{1} = [ XX ( 1 , 2 ) + XX ( 2 , 3 ) + XX ( 3 , 4 ) ] / 3 ;\end{matrix} \\ {Z}_{2} = [ XX ( 1 , 3 ) + XX ( 2 , 4 ) ] / 2 ; \end{matrix} \\ {Z}_{3} = XX ( 1 , 4 ) ;\end{matrix} & \\ ZZ = ( \begin{matrix}{Z}_{0} & {Z}_{1} & {Z}_{2} & {Z}_{3} \\ conj ( {Z}_{1} ) & {Z}_{0} & {Z}_{1} & {Z}_{2} \\ conj ( {Z}_{2} ) & conj ( {Z}_{1} ) & {Z}_{0} & {Z}_{1} \\ conj ( {Z}_{3} ) & conj ( {Z}_{2} ) & conj ( {Z}_{1} ) & {Z}_{0}\end{matrix} ) & ( 5 )\end{matrix}$$

Do singular value decomposition of ZZ we may have ZZ=V Λ conj(V)^{T} where V is an orthogonal unit matrix formed by eigenvectors of ZZ and Λ is a diagonal matrix formed by four eigenvalues.

Select the largest eigenvalue among the four and form the noise-vector matrix by those eigenvectors not corresponding to the largest eigenvector.

Form a polynomial and find the root by looking up table or by decomposing the companion matrix.

Convert the root into AOA in degrees and report it to Transmitter.

TABLE 4
Complexity of AOA Estimation Block

| | Real MPY | Real Addition | Total |
|---|---|---|---|
| ZZ | 9 | 6 | |
| SVD | 256 | 64 | |
| Polynomial | 2048 | 10 24 | |
| Roots | | | |
| AOA | 1 | 0 | 3408 |

Channel Estimation Block

Multipath channels can be estimated by LMS method using the known 26 training sequence. The four array outputs form four multipath channels, which contain all the information such as AOA, TOA, amplitude etc. Embodiments of the present invention fully exploit these multipath channels to achieve the best gain possible. We suppose the channel impulse has at least seven taps. Hence, we define a Toeplitz matrix S as

$$S = [ \begin{matrix}s ( {K}_{1} ) & s ( {K}_{1} + 1 ) & ⋯ & s ( {K}_{1} + 6 ) \\ s ( {K}_{1} - 1 ) & s ( {K}_{1} + 2 ) & ⋯ & s ( {K}_{1} + 7 ) \\ ⋯ & ⋯ & ⋯ & ⋯ \\ s ( {K}_{2} - 6 ) & s ( {K}_{2} - 5 ) & ⋯ & s ( {K}_{2} )\end{matrix} ]$$

to estimate seven time internals 1/280−33K˜3.7,μs
where s(K₁), s(K₁+1), . . . , s(K₂) are part of the known training sequence. Then each multipath channel impulse response can be obtained by solving the following linear equations:

$$\begin{matrix}\begin{matrix}\begin{matrix}S [ \begin{matrix}ch1 ( 6 ) \\ ch1 ( 5 ) \\ ⋮ \\ ch1 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y1 ( {K}_{1} + 6 ) \\ y1 ( {K}_{1} + 7 ) \\ ⋮ \\ y1 ( {K}_{2} )\end{matrix} ] \\ S [ \begin{matrix}ch2 ( 6 ) \\ ch2 ( 5 ) \\ ⋮ \\ ch2 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y2 ( {K}_{1} + 6 ) \\ y2 ( {K}_{1} + 7 ) \\ ⋮ \\ y2 ( {K}_{2} )\end{matrix} ]\end{matrix} \\ S [ \begin{matrix}ch3 ( 6 ) \\ ch3 ( 5 ) \\ ⋮ \\ ch3 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y3 ( {K}_{1} + 6 ) \\ y3 ( {K}_{1} + 7 ) \\ ⋮ \\ y3 ( {K}_{2} )\end{matrix} ]\end{matrix} \\ S [ \begin{matrix}ch4 ( 6 ) \\ ch4 ( 5 ) \\ ⋮ \\ ch4 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y4 ( {K}_{1} + 6 ) \\ y4 ( {K}_{1} + 7 ) \\ ⋮ \\ y4 ( {K}_{2} )\end{matrix} ]\end{matrix}$$

The explicit least mean square error solutions are:

$$\begin{matrix}\begin{matrix}\begin{matrix}[ \begin{matrix}ch1 ( 6 ) \\ ch1 ( 5 ) \\ ⋮ \\ ch1 ( 0 )\end{matrix} ] = {( {conj ( S )}^{T} S )}^{- 1} {conj ( S )}^{T} [ \begin{matrix}y1 ( {K}_{1} + 6 ) \\ y1 ( {K}_{1} + 7 ) \\ ⋮ \\ y1 ( {K}_{2} )\end{matrix} ] , \\ [ \begin{matrix}ch2 ( 6 ) \\ ch2 ( 5 ) \\ ⋮ \\ ch2 ( 0 )\end{matrix} ] = {( {conj ( S )}^{T} S )}^{- 1} {conj ( S )}^{T} [ \begin{matrix}y2 ( {K}_{1} + 6 ) \\ y2 ( {K}_{1} + 7 ) \\ ⋮ \\ y2 ( {K}_{2} )\end{matrix} ] ,\end{matrix} \\ [ \begin{matrix}ch3 ( 6 ) \\ ch3 ( 5 ) \\ ⋮ \\ ch3 ( 0 )\end{matrix} ] = {( {conj ( S )}^{T} S )}^{- 1} {conj ( S )}^{T} [ \begin{matrix}y3 ( {K}_{1} + 6 ) \\ y3 ( {K}_{1} + 7 ) \\ ⋮ \\ y3 ( {K}_{2} )\end{matrix} ] ,\end{matrix} \\ [ \begin{matrix}ch4 ( 6 ) \\ ch4 ( 5 ) \\ ⋮ \\ ch4 ( 0 )\end{matrix} ] = {( {conj ( S )}^{T} S )}^{- 1} {conj ( S )}^{T} [ \begin{matrix}y4 ( {K}_{1} + 6 ) \\ y4 ( {K}_{1} + 7 ) \\ ⋮ \\ y4 ( {K}_{2} )\end{matrix} ] .\end{matrix}$$

As the matrix S is formed by the known training sequence, the inverse matrix can be pre-calculated and stored in the memory. The total complexity for estimating the four multipath channels is given in Table 5.

TABLE 5
Complexity of Channel Estimation Block

| | Real MPY | Real addition | Total |
|---|---|---|---|
| Ch1 | 4 * (7 * 21 + 7 * 7) | 2 * (7 * 20 + 7 * 6) | |
| Ch2 | 784 | 364 | |
| Ch3 | 784 | 364 | |
| Ch4 | 784 | 364 | 4592 |

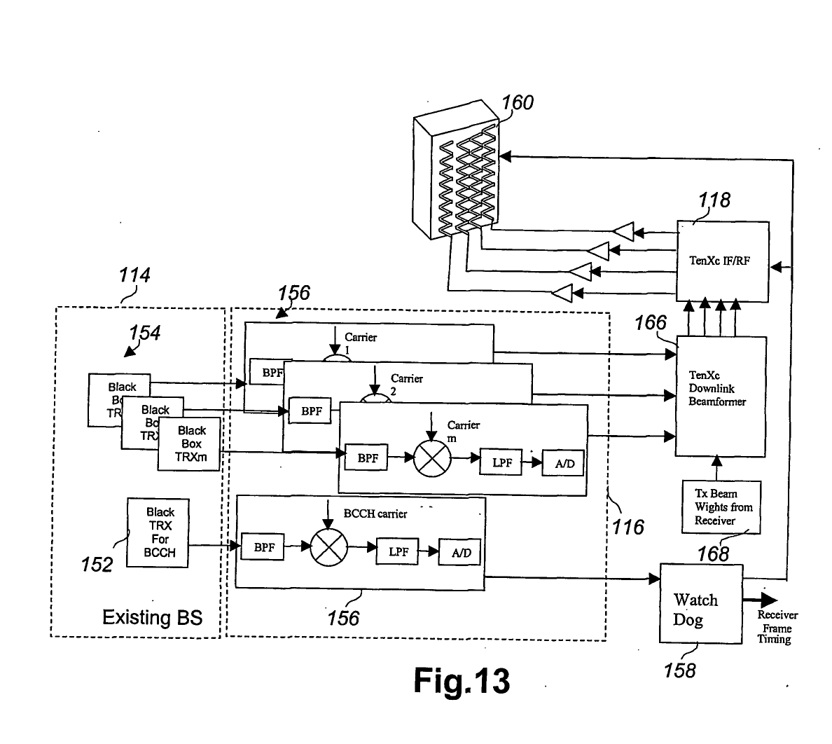

Referring to FIG. 13, there is illustrated in a block diagram a transmitter for the Hybrid Space-Time Diversity System in accordance with an embodiment of the present invention. An existing transmitter 150 includes a BCCH TRX 152 and a plurality of channel transmitters 154. An RF/IF converter includes transmitter chains 156 in the current deployed base station. The RF signal from 152 goes through the transmitter chain 156, which down converts the signal into base band signal, a watchdog function block 158 detects all the network information such as frame timing, training sequence, hoping sequence, which are fed into IF/RF block 118, antennas 160, and the receiver portion 104 of an appliqué intelligent antenna system (FIG. 12). The plurality of transmitters 154 for communication channels are each having coupled to a transmitter chain 156 which down converts the signal and converts it to a digital signal for processing. A downlink beamformer function block 166 with weights from the receiver 168 processes the digital signals and provides an output to the IF/RF block 118 along with the BCCH output from the watchdog function block 158.

A deployment of the Hybrid Space-Time Diversity antenna system is shown in FIGS. 12 and 13, includes the following main components:

1 . Three four-element antenna systems 160 (or, if deployed on a building in an urban setting, four four-element systems).
120° scan angle for semi-urban or rural deployments
90° scan angle for urban deployment
60° scan or look angle for certain urban deployments

2. Certain electronic components on the tower or building, consisting of:
LNAs
Lightning arrestors
Converters to reduce the number of cables down the tower

3. Cabling to bring the RF down the tower or building; and DC power up the tower to feed the electronics

4. User defined Shelter and base station.

Further detail of an implementation of the antenna system include the following components:

1. Four antenna elements
Beamwidths:
   Choice of 120°, 90° or 60° in the azimuthally plane
   5.6° in the elevation plane
Physical size
   Height: 6 ft
   Width: 14 inches
   Depth: 6 inches
Gain: options;
   Azimuths: 120°, 90° and 60°:
   17.1 dB, 18.3 dB, and 20.1 dB, respectively.

2. Four LNAs and I Mixers

3. Four phase coherent receivers, producing I and Q outputs (Here they represent in phase and quadrature phase)

4. Multiplexer

TenXc Watch-Dog 158

As the intelligent antenna system in accordance with an embodiment of the present invention may be hooked up to transmitters of various vendor's TRX, the base station information such as frame number, timing, timing advance, frequency hopping pattern may not be directly available. In this case a Watchdog function assists to get all this information when necessary. The Watch Dog function is assigned the following responsibilities.
1. Regularly check slot 0 of BCCH carrier, particularly do a fast search for frame boundary by using both FB and SB.
2. Decode SB to calculate T1, T2, T3′ and then derive exact frame number
3. Calculate the frequency-hopping pattern.
4. Decode BCCH norm or extension information, which might be carried in either, slot 0, or slot 2, or slot 4 or slot 6 depending on the deployed control channel combination. This information can be used to get Timing advance and therefore for downlink beamforming power control.
5. Decode PCH.
6. Decode AGCH. This information along with the information acquired from RACH (initial AOA here) can be used for mobile positioning and therefore downlink beamforming.
7. Decode NCH.
   Frequency Correction Channel

Frequency Correction Channel (FCCH) is a downlink-broadcasting channel. It is carried by frequency C0 (BCCH carrier) and always locates at slot 0. This burst is a constant burst with 0's fed into the whole slot. Therefore this burst causes a constant phase signal, in fact, the resulting signal is an unmodulated signal with a constant frequency C0(MHz)+1625/24 (kHz). A mobile phone first refers to this frequency and adjusts its local oscillator (LO) to achieve a frequency synchronization with the BS.

This burst appears every 10 frames counting started with 51 frames cycle numerology. The Watch Dog performs a fast sliding correlation to obtain frame boundary information.

Further detail on the FCCH Channel structure can be found in the GSM standard (ref. GSM 05.02)

Synchronization Channel

The synchronization channel (SCH) carries frame synchronization information and base station (BS) identification. After decoding this channel, a mobile terminal knows which BS connection to hook up and the exact frame number the BS is transmitting. The synchronization burst (SB) is always paired with the frame burst (FB) that appears just 8 slots later. In other words, it always appears at slot 0 of a frame next to the frame a FB appears. As the present intelligent system needs to decode this channel, we will detail this channel information format and channel structure in the following paragraphs.

SCH Message Format and Bits Ordering

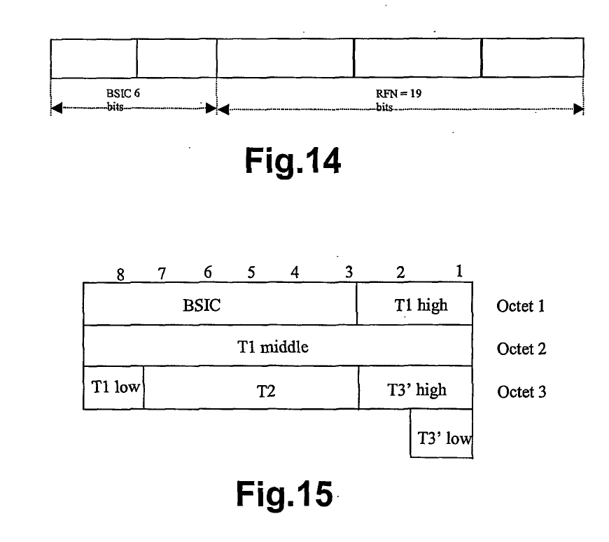

The information carried in SCH is (a) the base station identity code (BSIC) of the base station. (b) T1, T2, T3′, three parts of the reduced TDMA frame number (RFN) as specified in TS GSM 05.02. The FIGS. 14 and 15 illustrate the detailed arrangement this information in the message. Refer ETSI TS 04.08 for more detail.

SCH Encoding

The burst carrying the synchronization information on the downlink BCCH, the downlink CPBCCH for Compact, and in CTS the information of the CTSBCH-SB and the access request message of the CTSARCH, has a different structure. It contains 25 information bits {d(0),d(1), . . . , d(24)}, 10 parity bits {p(0),p(1), . . . , p(9)} and 4 tail bits.

The ten parity bits {p(0),p(1), . . . , p(9)} are defined in such a way that in GF(2) the binary polynomial:
d(0)D34+ . . . +d(24)D10+p(0)D9+ . . . +p(9), when divided by:
D10+D8+D6+D5+D4+D2+1, yields a remainder equal to:
D9+D8+D7+D6+D5+D4+D3+D2+D+1.

Thus the encoded bits {u(0),u(1), . . . , u(38)} are:
u(k)=d(k) for k=0, 1, . . . , 24
u(k)=p(k−25) for k=25, 26, . . . , 34
u(k)=0 for k=35, 36, 37, 38 (tail bits)

The bits {e(0),e(1), . . . , e(77)} are obtained by the same convolution code of rate ½ as for TCH/FS, defined by the polynomials:
G0=1+D3+D4
G1=1+D+D3+D4
with
e(2k)=u(k)+u(k−3)+u(k−4)
e(2k+1)=u(k)+u(k−1)+u(k−3)+u(k−4) for k=0, 1 . . . , 77; u(k)=0 for k<0

Synchronization Burst Transmission

| Bit Number | | Contents | |
|---|---|---|---|
| (BN) | Length | of field of field | Definition |
| 0-2 | 3 | tail bits | 05.02 or below |
| 3-41 | 39 | encrypted bits (e0..e38) | 05.03 |
| 42-105 | 64 | extended training sequence bit | 05.02 |
| 106-144 | 39 | encrypted bits (e39...e77) | 05.03 |
| 145-147 | 3 | tail bits | 000 |
| 148-156 | 8.25 | guard period (bits) | 05.02 or below |

where the “tail bits” are defined as modulating bits with states as follows:
(BN0, BN1, BN2) = (0, 0, 0) and (BN145, BN146, BN147) = (0, 0, 0)
where the “extended training sequence bits” are defined as modulating bits with states as follows:
(BN42, BN43 ... BN105) = (1, 0, 1, 1, 1, 0, 0, 1, 0, 1, 1, 0, 0, 0, 1, 0, 0, 0, 0, 0, 0, 1, 0, 0, 0, 0, 0, 0, 1, 1, 1, 1, 0, 0, 1, 0, 1, 1, 0, 1, 0, 1, 0, 0, 0, 1, 0, 1, 0, 1, 1, 1, 0, 1, 1, 0, 0, 0, 0, 1, 1, 0, 1, 1)

Frame Number Calculation

After having decoded the SCH and mapped the bits into corresponding integers T1, T2, T3′, then the frame number FN can be calculated by
FN=51*((T3−T2)MOD 26)+T3+51*26*T1
Where T3=10*T3′. For further detail see the GSM standard, Ref GSM 05.10.
Frequency Hopping Sequence Generation

For a given set of parameters, the index to absolute radio frequency channel number (ARFCN) within the mobile allocation (MAI from 0 to N−1, where MAI=0 represents the lowest absolute radio frequency channel number (ARFCN) in the mobile allocation ARFCN is in the range 0 to 7 023 and the frequency value can be determined according to GSM 05.05 sec 2 with n=ARFCN), is obtained with the following algorithm:

```
  if HSN = 0 (cyclic hopping) then:
  MAI, integer (0 ... N−1) : MAI = (FN + MAIO) modulo N
else
  M, integer (0 ... 152) : M = T2 + RNTABLE((HSN xor T1R) + T3)
  S, integer (0 ... N−1) : M′ = M modulo (2 \hat{ } NBIN)
  T′ = T3 modulo (2 \hat{ } NBIN)
if M′ < N then:
  S = M′
else
  S = (M′+T′) modulo N
  MAI, integer (0 ... N−1) : MAI = (S + MAIO) modulo N
End
```

NOTE: Due to the procedure used by the mobile for measurement reporting when DTX is used, the use of cyclic hopping where (N)mod 13=0 should be avoided.
where:
T1R: time parameter T1, reduced modulo 64 (6 bits)
T3: time parameter, from 0 to 50 (6 bits)
T2: time parameter, from 0 to 25 (5 bits)
NBIN: number of bits required to represent N=INTEGER(log2(N)+1)
ˆ: raised to the power of
xor: bit-wise exclusive or of 8 bit binary operands.
MIAO: Mobile Allocation Offset Index (0 to N−1, 6 bits).
   Downlink Beamformer for POC

In order to simplify the implementation complexity, downlink beamformer for POC will be a fixed beam rather than adaptive one. Each sector has seven pre-designed fixed beams, a respective one pointing to −45, −30, −15, 0, 15, 30, 45 degrees. The corresponding weight vectors are named as
Wₐ=[wₐ(1)wₐ(2)wₐ(3)wₐ(4)], W_{b}=[w_{b}(1)w_{b}(2)w_{b}(3)w_{b}(4)], W_{c}=[w_{c}(1)w_{c}(2) w_{c}(3)w_{c}(4)], W_{d}=[w_{d}(1)w_{d}(2)w_{d}(3)w_{d}(4)], Wₑ=[wₑ(1)wₑ(2)wₑ(3)wₑ(4)], W_{f}=[w_{f}(1)w_{f}(2)w_{f}(3)w_{f}(4)], W_{g}=[w_{g}(1)w_{g}(2)w_{g}(3)w_{g}(4)].

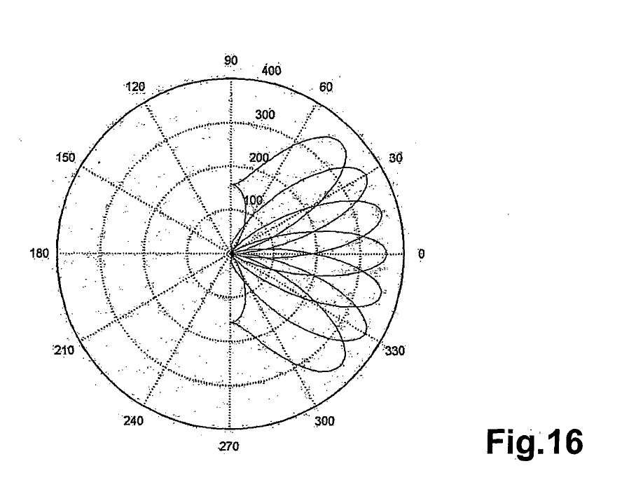

Referring to FIG. 16, there is graphically illustrated downlink beam patterns.

What is claimed is:

1. A method of beam forming comprising the steps of:
in an appliqué intelligent antenna system, monitoring broadcast channels of a mobile wireless base station;
monitoring a frequency burst broadcast by the base station and synchronizing the appliqué system in frequency;
monitoring a synchronization burst in the broadcasting channel and synchronizing the appliqué system with the mobile wireless base station in time.

2. A method as claimed in claim 1 further comprising the step of the base station receiving an access response for a remote terminal and in response thereto, including any processing delay of the appliqué system as part of a round-trip delay for the remote terminal;

3. A method as claimed in claim 2 wherein the step of the base station including any processing delay includes determining a timing advance value corresponding to a round-trip delay plus an appliqué system processing delay.

4. A method as claimed in claim 2 further comprising the step of the base station transmitting the timing advance value to instruct the remote terminal to transmit earlier than the normal system time thereby compensating for both the round-trip delay and the appliqué system processing delay.

5. A method as claimed in claim 1 wherein the step of monitoring a synchronization burst includes the step of detecting locally the system information carried by synchronization burst.

6. A method as claimed in claim 2 wherein the step of detecting includes regularly checking a slot 0 of broadcast control channel (BCCH) carrier.

7. A method as claimed in claim 6 wherein the step of detecting includes the steps of doing fast frequency synchronization and searching for a frame boundary by using both a frequency burst (FB) and a synchronization burst (SB).

8. A method as claimed in claim 7 including a steps of decoding the synchronization burst (SB) to determine three parts of the reduced TDMA frame number (RFN) T1, T2, T3′ and to derive an exact frame number.

9. A method as claimed in claim 8 including a step of calculating the frequency-hopping pattern.

10. A method as claimed in claim 9 including a step of decoding BCCH information to obtain timing advance for downlink beam forming power control.

11. A method as claimed in claim 10 including a step of decoding a paging channel (PCH).

12. A method as claimed in claim 10 including a step of decoding an access grant channel (AGCH).

13. A method as claimed in claim 12 including a step of determining mobile terminal positioning using information from the access grant channel.

14. A method as claimed in claim 10 including a step of decoding a request access channel (RACH) from a remote terminal.

15. A method as claimed in claim 14 including a step of decoding an access grant channel (AGCH).

16. A method as claimed in claim 15 including a step of determining mobile terminal positioning using information from access request and access grant channels.

17. A method as claimed in claim 16 including wherein the step of determining the mobile terminal position includes the step of determining angle of arrival of a response received from the remote terminal.

18. A method as claimed in claim 17 wherein the step of determining the angle of arrival includes the step of determining a covariance matrix XX, where X is given by:
$$[ \begin{matrix}R1 ( 62 ) R2 ( 62 ) R3 ( 62 ) R4 ( 62 ) \\ R1 ( 63 ) R2 ( 63 ) R3 ( 63 ) R4 ( 63 ) \\ R1 ( 64 ) R2 ( 64 ) R3 ( 64 ) R4 ( 64 ) \\ ⋮ \\ R1 ( 87 ) R2 ( 87 ) R3 ( 87 ) R4 ( 87 )\end{matrix} ]$$
$$And XX = {X}^{*} \cdot X$$

19. A method as claimed in claim 18 wherein the step of determining the angle of arrival includes the step of forming a Hermitian Toeplitz matrix by using XX with the following procedures
$$\begin{matrix}\begin{matrix}\begin{matrix}\begin{matrix} {Z}_{0} = [ XX ( 1 , 1 ) + XX ( 2 , 2 ) + XX ( 3 , 3 ) + XX ( 4 , 4 ) ] / 4 ; \\ {Z}_{1} = [ XX ( 1 , 2 ) + XX ( 2 , 3 ) + XX ( 3 , 4 ) ] / 3 ;\end{matrix} \\ {Z}_{2} = [ XX ( 1 , 3 ) + XX ( 2 , 4 ) ] / 2 ; \end{matrix} \\ {Z}_{3} = XX ( 1 , 4 ) ;\end{matrix} \\ ZZ = ( \begin{matrix}{Z}_{0} & {Z}_{1} & {Z}_{2} & {Z}_{3} \\ conj ( {Z}_{1} ) & {Z}_{0} & {Z}_{1} & {Z}_{2} \\ conj ( {Z}_{2} ) & conj ( {Z}_{1} ) & {Z}_{0} & {Z}_{1} \\ conj ( {Z}_{3} ) & conj ( {Z}_{2} ) & conj ( {Z}_{1} ) & {Z}_{0}\end{matrix} )\end{matrix}$$

20. A method as claimed in claim 19 wherein the step of determining the angle of arrival includes a step of performing singular value decomposition of ZZ to have ZZ=V Λ conj(V)^{T}, where V is an orthogonal unit matrix formed by eigenvectors of ZZ and Λ is a diagonal matrix formed by four eigenvalues.

21. A method as claimed in claim 20 wherein the step of determining the angle of arrival includes a step of selecting a largest eigenvalue from among the four eigenvalues and forming a noise vector matrix by those eigenvectors not corresponding to the largest eigenvector.

22. A method as claimed in claim 21 wherein the step of determining the angle of arrival includes the step of forming a polynomial and finding a root by referring to a look-up table.

23. A method as claimed in claim 22 wherein the step of determining the angle of arrival includes the step of converting the root into an angle of arrival in degrees.

24. A method as claimed in claim 23 including the step of downlink beam forming the intelligent antenna array for the mobile terminal in dependence upon the angle of arrival of the strongest multipath signal.

25. A method as claimed in claim 21 wherein the step of determining the angle of arrival includes the step of forming a polynomial and finding a root by decomposing a companion matrix.

26. A method as claimed in claim 25 wherein the step of determining the angle of arrival includes the step of converting the root into an angle of arrival in degrees.

27. A method as claimed in claim 26 including the step of downlink beam forming the intelligent antenna array for the mobile terminal in dependence upon the angle of arrival of the strongest multipath signal.

28. A method as claimed in claim 27 wherein the step of downlink beam forming includes the steps framing data to form four slot data vectors y1, y2, y3, y4 where:
y₁=R1(1),R1(2),R1(3),R1(4), . . . , R1(61),R1(62), . . . , R1(87),R1(88), . . . , R1(145),R1(146),R1(147),R1(148), R1(149), . . . ,R1(156)
y₂=R2(1),R2(2),R2(3),R2(4), . . . , R2(61),R2(62), . . . , R2(87),R2(88), . . . , R2(145),R2(146),R2(147),R2(148), R2(149), . . . , R2(156)
y₃=R3(1),R3(2),R3(3),R3(4), . . . , R3(61),R3(62), . . . , R3(87),R3(88), . . . , R3(145),R3(146),R3(147)R3(148), R3(149), . . . , R3(156)
y₄=R4(1),R4(2),R4(3),R4(4), . . . , R4(61),R4(62), . . . , R4(87),R4(88), . . . , R4(145),R4(146),R4(147),R4(148), R4(149), . . . , R4(156);
extracting data vectors corresponding a training sequence, that is those having a data position from index 62 to index 87;
estimating multipath channels with the following formulae
$$S = [ \begin{matrix}s ( {K}_{1} ) & s ( {K}_{1} + 1 ) & ⋯ & s ( {K}_{1} + 6 ) \\ s ( {K}_{1} - 1 ) & s ( {K}_{1} + 2 ) & ⋯ & s ( {K}_{1} + 7 ) \\ ⋯ & ⋯ & ⋯ & ⋯ \\ s ( {K}_{2} - 6 ) & s ( {K}_{2} - 5 ) & ⋯ & s ( {K}_{2} )\end{matrix} ]$$
where s(K₁), s(K₁+1), . . . , s(K₂) are part of the known training sequence transmitted by a mobile terminal that is also known by the base station; and
then obtaining each multipath channel impulse response by solving the following linear equations:
$$\begin{matrix}\begin{matrix}\begin{matrix}S [ \begin{matrix}ch1 ( 6 ) \\ ch1 ( 5 ) \\ ⋮ \\ ch1 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y1 ( {K}_{1} + 6 ) \\ y1 ( {K}_{1} + 7 ) \\ ⋮ \\ y1 ( {K}_{2} )\end{matrix} ] \\ S [ \begin{matrix}ch2 ( 6 ) \\ ch2 ( 5 ) \\ ⋮ \\ ch2 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y2 ( {K}_{1} + 6 ) \\ y2 ( {K}_{1} + 7 ) \\ ⋮ \\ y2 ( {K}_{2} )\end{matrix} ]\end{matrix} \\ S [ \begin{matrix}ch3 ( 6 ) \\ ch3 ( 5 ) \\ ⋮ \\ ch3 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y3 ( {K}_{1} + 6 ) \\ y3 ( {K}_{1} + 7 ) \\ ⋮ \\ y3 ( {K}_{2} )\end{matrix} ]\end{matrix} \\ S [ \begin{matrix}ch4 ( 6 ) \\ ch4 ( 5 ) \\ ⋮ \\ ch4 ( 0 )\end{matrix} ] + [ \begin{matrix}N ( {K}_{1} ) \\ N ( {K}_{1} + 1 ) \\ ⋮ \\ N ( {K}_{2} - 6 )\end{matrix} ] = [ \begin{matrix}y4 ( {K}_{1} + 6 ) \\ y4 ( {K}_{1} + 7 ) \\ ⋮ \\ y4 ( {K}_{2} )\end{matrix} ]\end{matrix}$$
having explicit least mean square error solutions:
$$\begin{matrix}\begin{matrix}\begin{matrix}[ \begin{matrix}ch1 ( 6 ) \\ ch1 ( 5 ) \\ ⋮ \\ ch1 ( 0 )\end{matrix} ] = {( {conj ( S )}^{T} S )}^{- 1} [ \begin{matrix}y1 ( {K}_{1} + 6 ) \\ y1 ( {K}_{1} + 7 ) \\ ⋮ \\ y1 ( {K}_{2} )\end{matrix} ] , \\ [ \begin{matrix}ch2 ( 6 ) \\ ch2 ( 5 ) \\ ⋮ \\ ch2 ( 0 )\end{matrix} ] = {( {conj ( S )}^{T} S )}^{- 1} [ \begin{matrix}y2 ( {K}_{1} + 6 ) \\ y2 ( {K}_{1} + 7 ) \\ ⋮ \\ y2 ( {K}_{2} )\end{matrix} ] ,\end{matrix} \\ [ \begin{matrix}ch3 ( 6 ) \\ ch3 ( 5 ) \\ ⋮ \\ ch3 ( 0 )\end{matrix} ] = {( {conj ( S )}^{T} S )}^{- 1} [ \begin{matrix}y3 ( {K}_{1} + 6 ) \\ y3 ( {K}_{1} + 7 ) \\ ⋮ \\ y3 ( {K}_{2} )\end{matrix} ] ,\end{matrix} \\ [ \begin{matrix}ch4 ( 6 ) \\ ch4 ( 5 ) \\ ⋮ \\ ch4 ( 0 )\end{matrix} ] = {( {conj ( S )}^{T} S )}^{- 1} [ \begin{matrix}y4 ( {K}_{1} + 6 ) \\ y4 ( {K}_{1} + 7 ) \\ ⋮ \\ y4 ( {K}_{2} )\end{matrix} ] .\end{matrix}$$

29. A method as claimed in claim 28 wherein the matrix S is formed by the known training sequence and an inverse matrix is pre-determined and stored in memory.

30. A method as claimed in claim 28 wherein the step of downlink beam forming includes a step of forming a data matrix H
$$H = [ \begin{matrix}{y}_{1} ( k ) & {y}_{1} ( k + 1 ) & ⋯ & {y}_{1} ( k + 25 ) \\ {y}_{2} ( k ) & {y}_{2} ( k + 1 ) & ⋯ & {y}_{2} ( k + 25 ) \\ {y}_{3} ( k ) & {y}_{3} ( k + 1 ) & ⋯ & {y}_{3} ( k + 25 ) \\ {y}_{4} ( k ) & {y}_{4} ( k + 1 ) & ⋯ & {y}_{4} ( k + 25 )\end{matrix} ] - [ \begin{matrix}{ch}_{1} ( 0 ) & {ch}_{1} ( 1 ) & ⋯ & {ch}_{1} ( 6 ) \\ {ch}_{2} ( 0 ) & {ch}_{2} ( 1 ) & ⋯ & {ch}_{2} ( 6 ) \\ {ch}_{3} ( 0 ) & {ch}_{3} ( 1 ) & ⋯ & {ch}_{3} ( 6 ) \\ {ch}_{4} ( 0 ) & {ch}_{4} ( 1 ) & ⋯ & {ch}_{4} ( 6 )\end{matrix} ] \\ [ \begin{matrix}s ( k ) & s ( k + 1 ) & ⋯ & s ( k + 25 ) \\ s ( k - 1 ) & s ( k ) & ⋯ & s ( k + 24 ) \\ ⋯ & ⋯ & ⋯ & ⋯ \\ s ( k - 6 ) & s ( k - 5 ) & ⋯ & s ( k + 19 )\end{matrix} ] with k = 62.$$

31. A method as claimed in claim 30 wherein the step of downlink beam forming includes a step of choosing an optimal beam former by solving an optimization problem:
min{w^{T}ININ^{T}w=w^{T}HH^{T}w,s.t.∥w∥²=1}
whose solution is an eigenvalue problem of a 4×4 semi-definite positive Hermitian matrix, that has an explicit solution.

32. A method as claimed in claim 31 including a step of solving the optimization problem by doing eigenvalue decomposition for the 4×4 Hermitian matrix HH^{T}.

33. A method as claimed in claim 1 further comprising the step of uplink beam forming.

34. A method as claimed in claim 33 including the steps of:
estimating angle of arrival (AOA) estimation by determining a covariance matrix XX, where X is given by:
$$[ \begin{matrix}R1 ( 62 ) R2 ( 62 ) R3 ( 62 ) R4 ( 62 ) \\ R1 ( 63 ) R2 ( 63 ) R3 ( 63 ) R4 ( 63 ) \\ R1 ( 64 ) R2 ( 64 ) R3 ( 64 ) R4 ( 64 ) \\ ⋮ \\ R1 ( 87 ) R2 ( 87 ) R3 ( 87 ) R4 ( 87 )\end{matrix} ]$$
$$And XX = {X}^{*} \cdot X$$

35. A method as claimed in claim 34 wherein the step of determining the angle of arrival includes the step of determining a covariance matrix XX, where X is given by:
$$[ \begin{matrix}R1 ( 62 ) R2 ( 62 ) R3 ( 62 ) R4 ( 62 ) \\ R1 ( 63 ) R2 ( 63 ) R3 ( 63 ) R4 ( 63 ) \\ R1 ( 64 ) R2 ( 64 ) R3 ( 64 ) R4 ( 64 ) \\ ⋮ \\ R1 ( 87 ) R2 ( 87 ) R3 ( 87 ) R4 ( 87 )\end{matrix} ]$$
$$And XX = {X}^{*} \cdot X$$

36. A method as claimed in claim 35 wherein the step of determining the angle of arrival includes the step of forming a Hermitian Toeplitz matrix by using XX with the following procedures
$$\begin{matrix}{Z}_{0} = [ XX ( 1 , 1 ) + XX ( 2 , 2 ) + XX ( 3 , 3 ) + XX ( 4 , 4 ) ] / 4 ; \\ {Z}_{1} = [ XX ( 1 , 2 ) + XX ( 2 , 3 ) + XX ( 3 , 4 ) ] / 3 ; \\ {Z}_{2} = [ XX ( 1 , 3 ) + XX ( 2 , 4 ) ] / 2 ; \\ {Z}_{3} = XX ( 1 , 4 ) ; \\ ZZ = ( \begin{matrix}{Z}_{0} & {Z}_{1} & {Z}_{2} & {Z}_{3} \\ conj ( {Z}_{1} ) & {Z}_{0} & {Z}_{1} & {Z}_{2} \\ conj ( {Z}_{2} ) & conj ( {Z}_{1} ) & {Z}_{0} & {Z}_{1} \\ conj ( {Z}_{3} ) & conj ( {Z}_{2} ) & conj ( {Z}_{1} ) & {Z}_{0}\end{matrix} )\end{matrix}$$

37. A method as claimed in claim 36 wherein the step of determining the angle of arrival includes a step of performing singular value decomposition of ZZ to have ZZ=V Λ conj(V)^{T}, where V is an orthogonal unit matrix formed by eigenvectors of ZZ and Λ is a diagonal matrix formed by four eigenvalues.

38. A method as claimed in claim 27 wherein the step of determining the angle of arrival includes a step of selecting a largest eigenvalue from among the four eigenvalues and forming a noise vector matrix by those eigenvectors not corresponding to the largest eigenvector.

39. A method as claimed in claim 38 wherein the step of determining the angle of arrival includes the step of forming a polynomial and finding a root by referring to a look-up table.

40. A method as claimed in claim 39 wherein the step of determining the angle of arrival includes the step of converting the root into an angle of arrival in degrees.

41. A method as claimed in claim 38 wherein the step of determining the angle of arrival includes the step of forming a polynomial and finding a root by decomposing a companion matrix.

42. A method as claimed in claim 41 wherein the step of determining the angle of arrival includes the step of converting the root into an angle of arrival in degrees.

43. A method a claimed in claim 42 including a step of calculating four beam weights to form a downlink beam comprising a 30 degree beam pointing to the direction of the estimated AOA

44. A method as claimed in claim 1 wherein a separation between each antenna of the intelligent antenna array is (5^{1/2}−1)/2 times the wavelength.
